(19) United States
(12) Patent Application Publication
(10) Pub. No.: US 2002/0082033 A1
(43) Pub. Date: Jun. 27, 2002

(54) Method and apparatus for efficient packet-based communications over a wireless network

(76) Inventors: Anit Lohtia, Plano, TX (US); Paul Chan H. Tse, Allen, TX (US)

Correspondence Address: Dan C. Hu, TROP, PRUNER & HU, P.C., 8554 Katy Freeway, Ste. 100, Houston, TX, 77024, US

(21) Appl. No.: 09/769,836

(22) Filed: Jan. 25, 2001

Related U.S. Application Data
(60) Provisional application No. 60/257,788, filed on Dec. 21, 2000.

(51) Int. Cl. H04B 7/00; H04Q 7/20

(52) U.S. Cl. 455/517; 455/422

(57) ABSTRACT

A wireless communications system includes a mobile station and a base station system that are capable of communicating on the wireless links (uplink and downlink). The mobile station is capable of establishing a logical connection, such as a temporary block flow, on the uplink, while the base station system establishes a logical connection on the downlink. When either the mobile station or the base station system detects end of data transmission, a predetermined wait period is started during which the mobile station or base station system does not start a procedure to release the logical connection on the uplink or downlink.

### CROSS-REFERENCE TO RELATED APPLICATION

This claims the benefit under 35 U.S.C. §119(e) of U.S. Provisional Application Serial No. 60/257,788, entitled “Enhanced Radio Link for Efficient Packet-Based Communications Over a Wireless Network,” filed Dec. 21, 2000.

### TECHNICAL FIELD

The invention relates generally to providing efficient packet-based communications over a wireless network.

### BACKGROUND

Mobile communications systems, such as cellular or personal communications services (PCS) systems, are made up of a plurality of cells. Each cell provides a radio communications center in which a mobile unit establishes a call with another mobile unit or wireline unit connected to a public switched telephone network (PSTN). Each cell includes a radio base station, with each base station connected to a base station controller or mobile switching center that controls processing of calls between or among mobile units or mobile units and PSTN units.

Various wireless protocols exist for defining communications in a mobile network. One such protocol is a time-division multiple access (TDMA) protocol, such as the TIA/EIA-136 standard provided by the Telecommunications Industry Association (TIA). With TIA/EIA-136 TDMA, each channel carries a frame that is divided into six time slots to support multiple (3 or 6) mobile units per channel. Other TDMA-based systems include Global System for Mobile (GSM) communications systems, which use a TDMA frame divided into eight time slots (or burst periods). Another wireless communications technology is the code-division multiple access (CDMA) technology, such as according to the IS-95A or IS-95B CDMA protocol.

Traditional speech-oriented wireless systems utilize circuit-switched connection paths in which a channel (e.g., a time slot of a carrier having a frequency) is occupied for the duration of the connection between a mobile unit and the mobile switching center. Such a connection is optimum for communications that are relatively continuous, such as speech. However, data networks such as local area networks (LANs), wide area networks (WANs), and the Internet use packet-based connections, in which communication between nodes on a communications link is by data packets. Each node occupies the communications link only for as long as the node needs to send or receive data packets. With the rapid increase in the number of cellular subscribers in conjunction with the rising popularity of communications over data networks such as intranets or the Internet, a packet-based wireless data connection that provides convenient and efficient access to data networks, electronic mail, databases, and other types of data has become desirable.

Several packet-based wireless connection protocols have been proposed to provide more efficient connections between a mobile unit and a data network. One such protocol is the General Packet Radio Service (GPRS) protocol, which complements existing GSM systems. Another technology that builds upon GPRS is the Enhanced Data Rate for Global Evolution (EDGE) technology, which offers even higher data rates. The enhancement of GPRS by EDGE is referred to as Enhanced GPRS (EGPRS). Another variation of EGPRS is the EGPRS COMPACT technology. Yet another technology that provides packet-switched wireless communications is the UMTS (Universal Mobile Telecommunications System) technology, which is based on the Wideband CDMA (W-CDMA) protocol.

Typically, in a wireless network capable of communicating packet-based traffic, resources (e.g., a logical connection) are allocated to a mobile station only if there is actual data to transfer. Usually, it takes a relatively long time to allocate the resources to the mobile station. For example, in GPRS/EDGE networks, the setup time for establishing a logical connection, referred to as a temporary block flow (TBF), can take several seconds on the uplink (from the mobile station to the radio network) and on the downlink (from the radio network to the mobile station). Since packet-based communications are bursty in nature, the logical connection may be lost between the bursts. Thus, after a first burst of data has been transmitted, the logical connection is deallocated. When the mobile station or radio network is ready to communicate the next burst of packets, another logical connection needs to be established, which adds to delay in packet-based communications.

### SUMMARY

In general, according to one embodiment, a method of performing packet-based communications in a wireless network comprises establishing a connection over a wireless link between a mobile station and a radio access network system, transmitting data in the connection, and waiting a predetermined time delay period after end of data transmission. A procedure to release the connection is started after the predetermined delay period.

Some embodiments of the invention may have one or more of the following advantages. By waiting a time delay before releasing a connection between a mobile station and a radio access network system (such as a base station system), performance is enhanced for bursty packet-based communications. The enhancement is made possible by reducing the number of occurrences in which allocation of resources is needed for communication of a bursts of packets over a wireless link.

Other or alternative features or advantages will become apparent from the following description, from the drawings, and from the claims.

### BRIEF DESCRIPTION OF THE DRAWINGS

FIG. 1 is a block diagram of an embodiment of a communications system.

FIG. 2 is a block diagram of components in a mobile station, base station system, and serving General Packet Radio Service (GPRS) support node in the communications system of FIG. 1.

FIG. 3 is a flow diagram of a process performed by the mobile station of FIG. 2, in accordance with an embodiment.

FIG. 4 is a flow diagram of a process performed by the base station system of FIG. 2, in accordance with an embodiment.

FIG. 5 is a message flow diagram of a communications session in the communication system of FIG. 1.

FIGS. 6 and 7 are message flow diagrams of procedures to establish uplink and downlink connections between the mobile station and base station system of FIG. 2.

### DETAILED DESCRIPTION

In the following description, numerous details are set forth to provide an understanding of the present invention. However, it will be understood by those skilled in the art that the present invention may be practiced without these details and that numerous variations or modifications from the described embodiments may be possible.

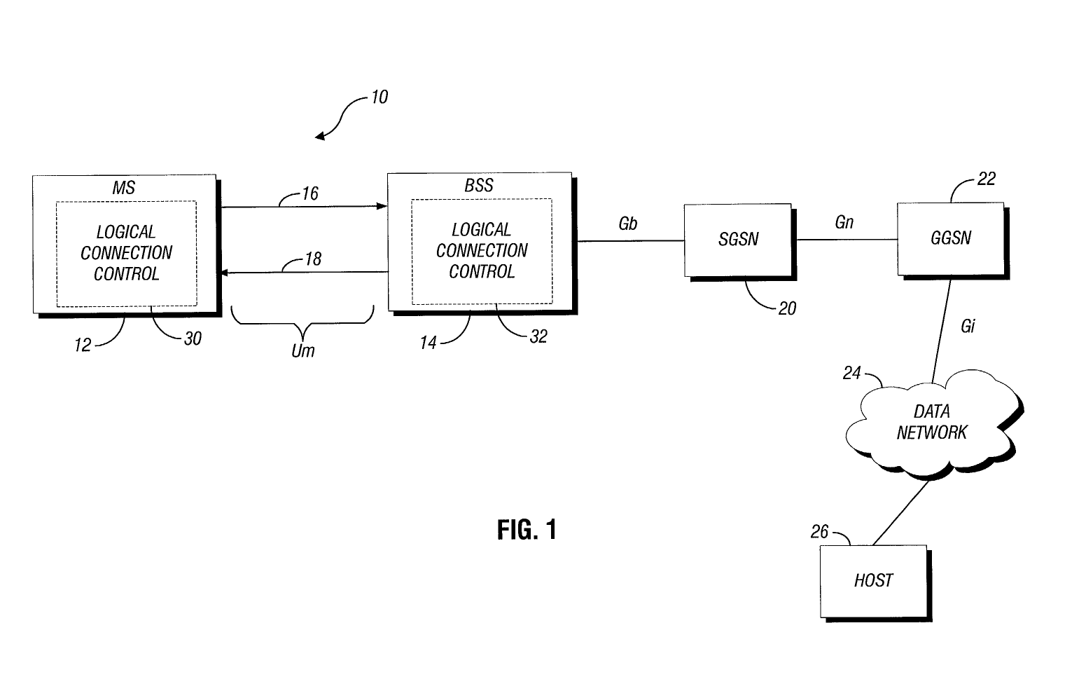

Referring to FIG. 1, a wireless communications network 10 includes a mobile station 12 and a base station system 14 that are capable of communicating with each other over radio frequency (RF) links 16 and 18. In one embodiment, according to GPRS (General Packet Radio Service) or EGPRS (Enhanced GPRS), the interface between the mobile station 12 and the base station system 14 is referred to as a Um interface. RF link 16 is the uplink, while RF link 18 is the downlink. Although only one mobile station 12 and one base station system 14 are illustrated, the wireless communications network 10 includes multiple mobile stations and base station systems. The base station system 14 includes a base station as well as a controller that controls various radio functions. More generally, the base station system can be referred to as a radio access network system, which can be any type of system providing wireless access to mobile stations.

As used here, reference to GPRS or “General Packet Radio Service” also covers the EGPRS or EGPRS COMPACT protocols, as set forth by the European Telecommunications Standards Institute (ETSI). Although reference is made to GPRS communications and elements in the described embodiments, techniques and apparatus according to some embodiments can be applied or extended to other types of wireless technologies, such as UMTS (Universal Mobile Telecommunications Systems) systems, which are based on the Wideband CDMA (W-CDMA) protocol.

The base station system 14 is coupled to a serving GPRS support node (SGSN) 20 over a Gb interface, which is in turn coupled to a gateway GPRS support node (GGSN) 22. Generally, the SGSN 20 manages communications with mobile stations within its coverage area as well as the detection of new mobile stations that have entered the coverage area. The GGSN 22 is an interface node to an external packet data network 24, such as an intranet or the Internet. In one embodiment, communications over the data network 24 is according to an Internet Protocol (IP). One version of IP is described in Request for Comments (RFC) 791, entitled “Internet Protocol,” dated September 1981; and another version of IP is described in RFC 2460, entitled “Internet Protocol, Version 6 (IPy6) Specification,” dated December 1998.

An IP network is a connectionless, packet-switched network. Packets communicated over an IP network may travel independently over any path (and possibly over different paths) to a destination point. The packets may even arrive out of order, with routing of the packets based on one or more addresses carried in each packet. Another type of packet-based data network is a connection-oriented, packet-based network, such as an Asynchronous Transfer mode (ATM) or Frame Relay network.

In the illustrated example, a host or other type of network system 26 is coupled to the data network 24. The mobile station 12 can perform packet-based communications with the host 26 through the radio infrastructure (including the base station system 14, SGSN 20, and GGSN 22) and the data network 24. Packet-based communications include, for examples, electronic mail, web browsing, and so forth. In packet-based communications, data is carried in packets across the communications link. For IP-based communications, routing of each packet is based on a network address (of the destination) carried in the header of the packet.

One type of connection that can be established between the mobile station 12 and the host 26 is a Transmission Control Protocol (TCP) connection. TCP is described in RFC 793, entitled “Transmission Control Protocol,” dated September 1981. TCP defines a transport layer that manages connections over IP networks. TCP is a connection-oriented protocol used for web and HTTP (Hypertext Transfer Protocol) communications. TCP was developed with assumptions that the underlying network is a fast, reliable network. In accordance with some embodiments of the invention, a mechanism is provided in the mobile station 12 and/or base station system 14 to provide relatively fast and efficient wireless network communications between the mobile station 12 and the base station system 14.

To communicate signaling and user data between the mobile station 12 and the base station system 14, a temporary block flow (TBF) is established either on the uplink 16 or the downlink 18 (depending on which of the peer entities is initiating the control signaling or data transfer). The data communicated between the mobile station 12 and the base station system 14 according to EGPRS are carried in logical link control (LLC) protocol data units (PDUs) on packet data channels (PDCHs). Each TBF is allocated radio resources on one or more PDCHs and comprises a number of RLC/MAC (radio link control/medium access control) blocks carrying one or more LLC PDUs. A TBF is temporary and is typically maintained for the duration of a data transfer (until there are no more RLC/MAC blocks to be transmitted and, in RLC acknowledged mode, all of the transmitted RLC/MAC blocks have been successfully acknowledged by the receiving entity).

The RLC layer defines procedures for segmentation and reassembly of LLC PDUs into RLC/MAC blocks, in addition to other tasks. The MAC layer defines the procedures that enable multiple mobile stations to share a common transmission medium, which includes several physical channels. In addition, the MAC layer defines procedures to support the provision of TBFs that allow the point-to-point transfer of signaling and user data between the mobile station and the base station system.

More generally, each TBF established on either the uplink 16 or the downlink 18 between the mobile station 12 and the base station system 14 is referred to as a “logical connection.” The establishment and release of such a logical connection is controlled by a logical connection control module 30 in the mobile station 12 and a logical connection control module 32 in the base station system 14. Although referred to as a single element, each logical connection control module 30 or 32 can actually include plural components, including components in the RLC and MAC layers of each of the mobile station 12 and base station system 14.

The following describes procedures to release the TBF in a GPRS or EGPRS system. In other embodiments, other mechanisms and procedures for releasing logical connections can be employed.

Typically, on the uplink 16, a mobile station sends an indication to the radio access network system (the base station system 14 in FIG. 1) as soon as the mobile station determines that its RLC/MAC send buffer is empty. In one embodiment, this indication is in the form of a countdown value (CV) set to the value zero. When the base station system 14 detects the end of the TBF (that is, when CV equals zero), the base station system 14 sends a PACKET UPLINK ACK/NACK message with a Final Ack Indicator bit set to the value “1.” Upon reception of the PACKET UPLINK ACK/NACK message, the mobile station 12 transmits a PACKET CONTROL ACKNOWLEDGMENT message and releases the TBF.

On the downlink 18, the base station system 14 initiates the release of a downlink TBF by sending an RLC data block with a Final Block Indicator (FBI) parameter set to the value “1.” Thus, on the downlink, the indication of end of data transmission is provided by the FBI parameter in an RLC data block. In response to receiving an RLC data block with the FBI bit set to the value “1,” the mobile station 12 transmits a PACKET DOWNLINK ACK/NACK message in a specified uplink block. Once the mobile station 12 has received all RLC data blocks of the TBF, the mobile station 12 then sends a PACKET DOWNLINK ACK/NACK message with the Final Ack Indicator bit set to the value “1.” Upon receiving the PACKET DOWNLINK ACK/NACK message, the base station system 14 releases the TBF after certain events occur.

Thus, conventionally, in each of the mobile station 12 and base station system 14, the procedure to initiate the release of the logical connection (e.g., the TBF on the uplink 16 or downlink 18) begins as soon as the send or transmit buffer in the respective mobile station 12 or base station system 14 has emptied. However, this may lead to premature release of the logical connection before all data in a particular data session has been transmitted. For example, in packet-based communications, data can be sent in several bursts, with a certain amount of delay between successive bursts.

In a conventional GPRS or EGPRS system, the procedure to initiate release of the TBF will occur as soon as the first burst is completed (that is, the last data block of the burst has been transmitted). When the subsequent burst is to be transmitted, a new TBF will have to be established. Due to the relatively large amount of time needed to establish a TBF, the premature release of a TBF can lead to inefficient packet-based communications.

In accordance with some embodiments of the invention, instead of starting a procedure to release the logical connection as soon as it is detected that the RLC/MAC send buffer of the mobile station 12 or base station system 14 is empty, a predetermined wait period is provided before the procedure is started. Thus, even though the RLC/MAC send buffer is empty in the mobile station 12 or base station system 14, the logical connection on the uplink 16 or downlink 18 is maintained for the predetermined wait period, which can be set using a timer. If there is additional data to be transferred (such as data in the next burst) before expiration of the timer, the data transfer can bypass the signaling procedure to establish a logical connection and start the data transfer faster. Since it is the logical connection (e.g., TBF) that is being maintained, no physical radio resources (e.g., a time slot of a frame or a carrier) are wasted.

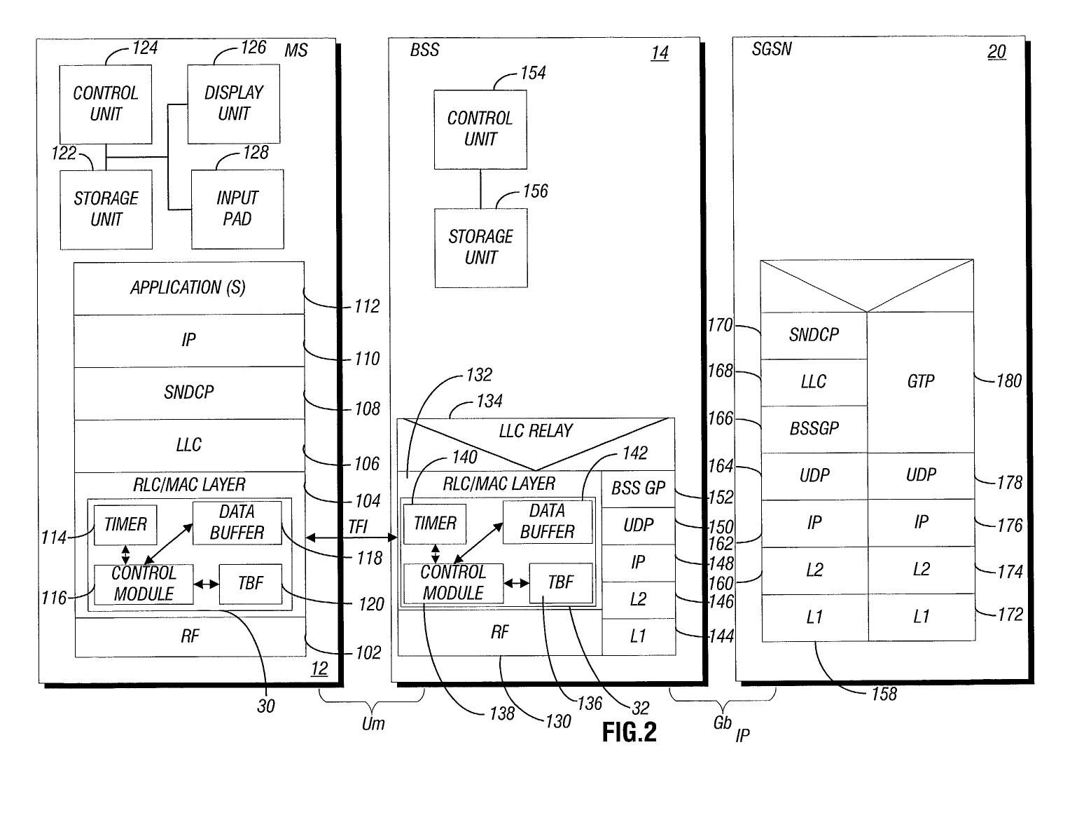

Referring to FIG. 2, components in the mobile station 12, base station system 14, and SGSN 20 are illustrated. The mobile station 12 includes a radio frequency (RF) transceiver 102 for communicating RF signals with the base station system 14. Above the RF transceiver 102 is the RLC/MAC layer 104 (which contains the logical connection control module 30).

In one example embodiment, the logical connection control module 30 includes a control module 116, a timer 114, a send data buffer 118, and a storage element 120 to store the uplink TBF state. The control module 116 manages the establishment and release of the uplink TBF. The uplink TBF is initiated or established when there is data to send in the send data buffer 118. Each TBF is assigned a TFI the uplink TBFs of different mobile stations are assigned different TFIs. The uplink TBF is released when there are no more data to send in the data buffer 118. When a TBF and associated TFI is released, it can be assigned for communication with another mobile station. The timer 114 provides a delay period for stating the procedure to release the uplink TBF after the data buffer 118 has emptied (or no longer contains data for transmission over the TBF).

Above the RLC/MAC layer 104 is the logical link control (LLC) layer 106. The LLC layer 106 provides a reliable logical link between the mobile station 12 and the SGSN 20. The LLC layer 106 provides services necessary to maintain a ciphered data link between the mobile station 12 and the SGSN 20. In addition, the LLC layer 106 supports procedures for point-to-point and point-to-multipoint delivery of LLC PDUs, procedures for detecting and recovery lost or corrupted LLC PDUs, and procedures for flow control of LLC PDUs between the mobile station 12 and SGSN 20. The LLC layer 106 uses a temporary logical link identity (TLLI) for addressing.

The mobile station also includes a subnetwork data conversion protocol (SNDCP) layer 108 situated above the LLC layer 106. The SNDCP layer 108 manages the transmission and reception of N-PDUs between the mobile station 12 and the SGSN 12. In addition, an Internet Protocol (IP) layer 110 (or alternatively, another type of packet data protocol or PDP layer) is provided to enable IP (or other packet-based) communications through the wireless infrastructure, including the base station system 14, SGSN 20, and GGSN 22, with a network system coupled to the data network 24. A transport layer (not shown), such as a TCP layer, is also provided above the IP layer 110. In addition, application routines or modules 112 are provided in the mobile station 12. As examples, such application routines or modules 112 include web browsers, e-mail applications, text chat applications, voice communications applications, and so forth.

Various software routines or modules in the mobile station 12, including the components of the logical connection control module 30, are executable on a control unit 124 in the mobile station 12. The control unit 124 is coupled to a storage unit 122, which is capable of storing data and instructions. A display unit 126 is provided in the mobile station 12 to display messages and other textual or graphical data. An input pad 128 (such as a numeric keypad) is also provided to enable entry of user selections or commands.

The base station system 14 includes a number of layers to interface to several layers of the mobile station 12. The base station system 14 also includes an RF transceiver 130 and an RLC/MAC layer 132. The logical connection control module 32 is in the RLCIMAC layer 132. In an arrangement that is similar to that of the mobile station 12, the logical connection control module 32 also includes a control module 138 to manage the establishment and release of downlink TBFs (each assigned a TFI). Multiple TBFs are maintained for different mobile stations. For a given time slot on a carrier (having a frequency), a number (e.g., 16 or 32) of TFIs can be associated with plural mobile stations to enable sharing of the time slot (or channel). Communications with each of the mobile stations occurs over a different TBF assigned a unique TFI.

In addition, the logical connection control module 32 in the base station system 14 also includes a send data buffer 142, a storage element 136 to store downlink TBF states, and a timer 140 to provide a delay period before the start of a procedure to release a downlink TBF. Plural timers may be used for corresponding downlink TBFs. The RLC/MAC layer 132 also includes other timers (not shown) for performing other tasks.

The base station system 14 also includes an LLC relay layer 134, which forwards LLC PDUs to the Gb interface stack made up of layers 144, 146, 148, 150, and 152. The Gb interface includes a lower physical layer (L1 layer) 144. In addition, an L2 layer 146 (or the data link layer) is provided above the L1 layer 144. Above the L2 layer 146 is an IP layer 148 to enable IP communications over the Gb interface between the base station system 14 and the SGSN 20. The Gb interface shown in FIG. 2 is a Gb_{IP} layer which is adapted to perform IP-based communications over the link with the SGSN 20. However, in another embodiment, instead of a Gb_{IP} interface, a Frame Relay-based Gb interface can be employed. In a Frame Relay link, virtual connections or circuits are established between the base station system 14 and the SGSN 20 for communicating data.

A transport layer (e.g., a User Datagram Protocol or UDP layer) 150 is provided above the IP layer 148. UDP is described in RFC 768, entitled “User Datagram Protocol,” dated August 1980. The layer above the UDP layer 150 is a BSSGP (Base Station System GPRS Protocol) layer 152. One function of the BSSGP layer 152 is to provide radio-related, OoS, and routing information used to transmit user data between the BSS 14 and the SGSN 20.

The various software routines or modules in the base station system 14, including the logical connection control module 32, are executable on a control unit 154 in the base station system 14. The control unit 154 is coupled to a storage unit 156 for storing data and instructions.

The SGSN 20 also includes protocol layers that communicate over the Gb interface with the base station system 14. The SGSN 20 includes an L1 layer 158, an L2 layer 160, an IP layer 162, a UDP layer 164, and a BSSGP layer 156. In addition, the SGSN 20 includes an LLC layer 168 and an SNDCP layer 170.

The SGSN 20 routes data received over the Gb interface to the Gn interface (and vice versa). The Gn interface similarly includes an L1 layer 172, an L2 layer 174, an IP layer 176, and a UDP layer 178. In addition, the Gn interface includes a GPRS Tunneling Protocol (GTP) layer 180 that manages the tunneling of signaling and data between the SGSN 20 and the GGSN 22.

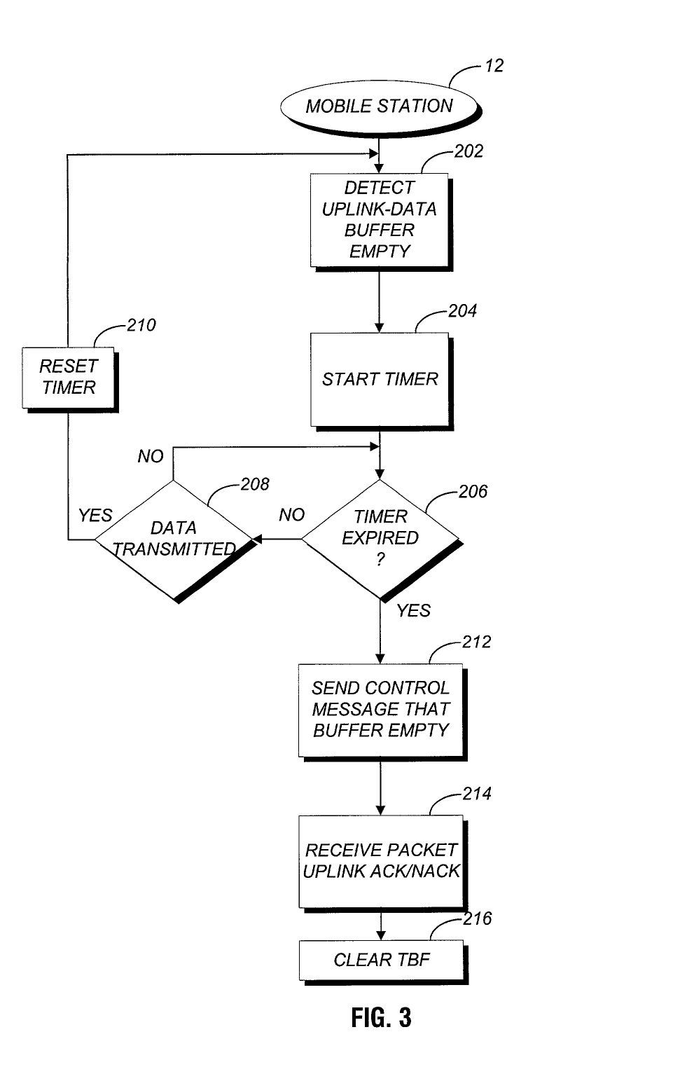

Referring to FIG. 3, a process performed by the mobile station 12 in accordance with one embodiment is illustrated. It is assumed that an uplink logical connection (e.g., a TBF) has been established by the control module 116 between the mobile station 12 and the base station system 14. When the control module 116 in the mobile station detects that its RLC/MAC send buffer 118 is empty (at 202), the control mobile 116 starts (at 204) the timer 114. The timer 114 is a configurable timer to enable optimization for different applications and network environments. The control module 116 determines (at 206) if the timer 114 has expired. If not, the control module 116 determines if more data has been transmitted (at 208) by determining if the RLC/MAC send buffer 118 is empty or not. If more data is to be transmitted, the timer 114 is reset (at 210). If more data has not yet arrived in the send buffer 118, the mobile station 12 waits for either the expiration of the timer 114 or for transmission data to be provided to the send buffer 118. If the timer expires, then the control module 116 sends (at 212) a control message or indication on the uplink 16 to indicate to the base station system 14 that its RLC/MAC send buffer 118 is empty. As mentioned above, the control message is in the form of the CV parameter having the value zero. In other embodiments, the indication can be a flag set to a given state carried in a message or data block. Upon receiving the PACKET UPLINK ACK/NACK message (at 214) with the Final Ack Indicator bit set to “1”, the control module 116 releases (at 216) the uplink TBF.

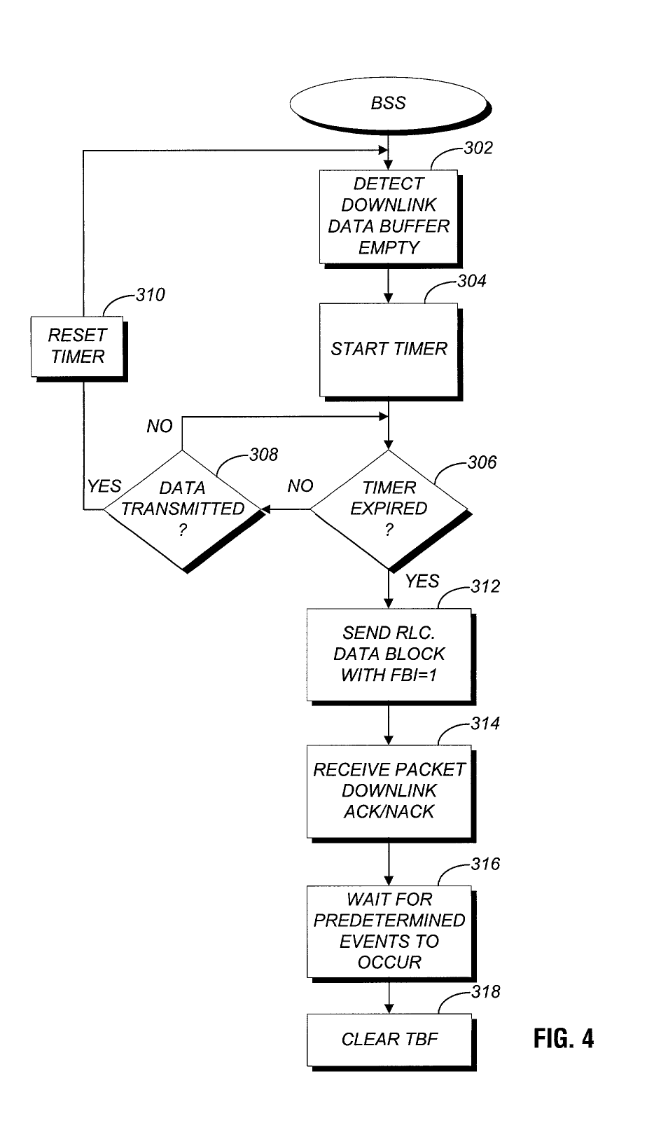

A similar procedure can be performed on the downlink 18. Referring to FIG. 4, after a downlink TBF has been established, the control module 138 in the RLC/MAC layer 132 of the base station system 14 detects (at 302) if the downlink send data buffer 142 (for the given TBF) is empty. If so, the timer 140 associated with the TBF 136 is started (at 304). The control module 138 determines (at 306) if the timer 140 has expired. If not, the control module 138 determines if more data has been transmitted (at 308) by determining if the downlink send buffer 142 is empty or not. If more data is to be transmitted, the timer 140 is reset (at 310). If more data has not arrived in the send buffer 142, the control module 138 waits for either the expiration of the timer 140 or for transmission data to be provided to the send buffer 142. If the timer 140 expires, then the control module 138 sends (at 312) an RLC data block with the FBI parameter set to the value “1.” Alternatively, in another embodiment, the control module 138 sends another type of indication. In response to receiving the RLC data block with the FBI parameter set to the value “1,” the mobile station 12 transmits a PACKET DOWNLINK ACK/NACK message, which is received (at 314) by the control module 138. The control module 138 then waits (at 316) for predetermined events to occur. Such events may include the expiration of another timer in the RLC/MAC layer 132. Once the other predetermined events have occurred, the control module 138 clears or releases (at 318) the downlink TBF.

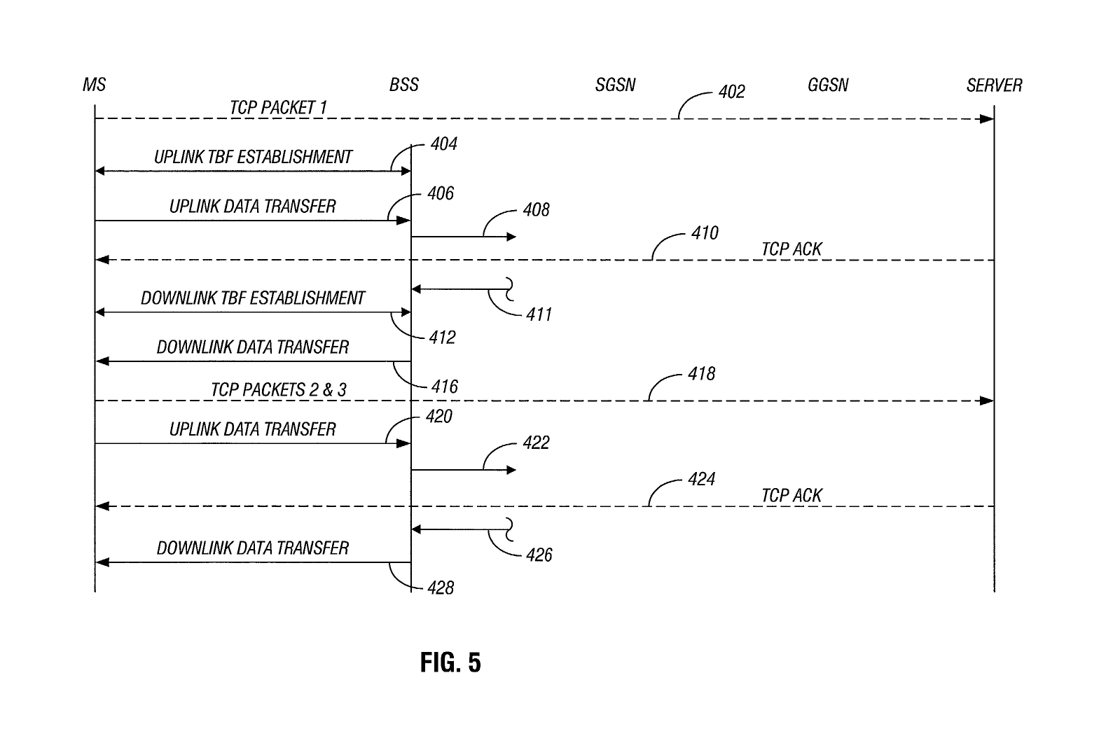

Referring to FIG. 5, a communications session between the mobile station 12 and a server (such as the host system 26 in FIG. 1) according to one example embodiment is illustrated. In the example, a TCP connection is established between the mobile station 12 and the server. The dashed lines in FIG. 5 indicate the desired data to be communicated between the mobile station 12 and the server (dashed lines do not represent the actual transmission of the data).

In the example, the mobile station 12 desires to transmit (at 402) TCP packet 1. To do so, the mobile station 12 performs an uplink TBF establishment (at 404). Once the uplink TBF is established, the mobile station 12 performs an uplink data transfer (at 406) with the base station system 14, in which RLC data blocks containing TCP packet 1 are transmitted. The base station system 14 then forwards the uplink data (at 408) through the SGSN 20, GGSN 22, and data network 24 to the server. Although data blocks containing TCP packet 1 has completed transmission, a procedure to release the uplink TBF is not started until the timer 114 (FIG. 2) has expired.

After receiving TCP packet 1, the server responds with a TCP Ack message (at 410) back to the mobile station 12. The Ack message is carried in one or more packets (at 411) from the server to the base station system 14. Since a downlink TBF has not been established yet, in response to receipt of the Ack packet(s), the base station system 14 initiates a downlink TBF establishment procedure (at 412). After the downlink TBF is established, the base station system 14 performs a downlink data transfer (416) in one or more RLC data blocks of the Ack message. The timer 140 in the base station system 14 is started to provide a wait period during which the procedure to release the downlink TBF is not started.

TCP packets 2 and 3 arrive (at 418) from an application 112 (FIG. 2) in the send buffer 118 for transfer on the uplink. Since the uplink TBF has not yet been released, the mobile station 12 can perform the uplink data transfer (420) without performing another uplink TBF establishment procedure. The data transferred to the base station system 14 is communicated (at 422) to the server through the SGSN 20, GGSN 22, and data network 24.

In response to receipt of TCP packets 2 and 3, the server responds (at 424) with a TCP Ack message. The message is communicated (at 426) to the base station system 14. In turn, the base station system performs a downlink data transfer (428) without having to establish a new downlink TBF if the downlink TBF has not yet been released.

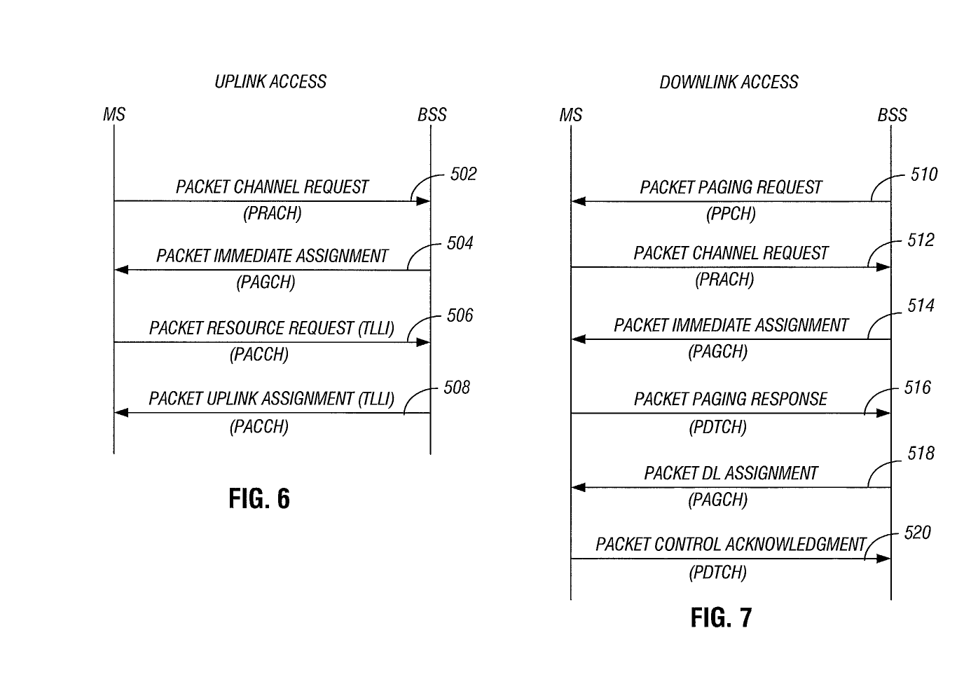

Referring to FIG. 6, an example uplink TBF establishment procedure is illustrated. The mobile station 12 first sends a packet channel request (at 502) to the base station system 14. The packet channel request is sent on a packet random access channel (PRACH). In response to the packet channel request, the base station system 14 sends a packet immediate assignment message (at 504) back to the mobile station on the packet access grant channel (PAGCH) to allocate downlink resources to the mobile station 12. This provides the resources needed by the mobile station 12 to send a packet resource request (at 506) on a packet associated control channel (PACCH). The packet resource request is sent by the mobile station 12 to request a change in the uplink resources assigned. The packet resource request contains a TLLI information element to identify the session between the mobile station 12 and the SGSN 20. In response to the packet resource request, the base station system 14 sends (at 508) a packet uplink assignment message on the PACCH. The packet uplink assignment message assigns uplink resources to the mobile station 12, including the TFI for the uplink TBF, the number of RLC data blocks granted, whether fixed or dynamic allocation is performed, the time slot to use for communications, and the carrier frequency to use.

The procedure shown in FIG. 6 is relatively time consuming, and can take up to between 2 and 3 seconds, in one example system. Thus, if the procedure illustrated in FIG. 6 needs to be performed with each communication of a burst of packets from the mobile station 12 to the base station system 14, then a substantial delay is introduced into uplink communications.

Referring to FIG. 7, a procedure by which the base station system 14 initiates a downlink TBF is illustrated. The base station system 14 first sends a packet paging request (at 510) on the packet paging channel (PPCH). The packet paging request is a request for TBF connection establishment. In response to the packet paging request, the mobile station 12 sends a packet channel request (at 512) on the PRACH, which is similar to the packet channel request sent at 502 in FIG. 6. In response to the packet channel request, the base station system 14 sends a packet immediate assignment message (at 514) on the PAGCH. In response to the packet immediate assignment message, the mobile station 12 sends a packet paging response (at 516) on the packet data traffic channel (PDTCH) to the base station system 14. Next, the base station system 14 sends a packet downlink assignment message (at 518) to the mobile station 12 to assign downlink resources to the mobile station 12. One of the resources assigned is the TFI of the downlink TBF. In response, the mobile station 12 sends a packet control acknowledgment message (at 520) on the PDTCH. Again, the procedure to establish the downlink TBF is also relatively time consuming.

Thus, generally, a mechanism according to some embodiments is provided to enhance performance of uplink and downlink packet-based communications, in which a logical connection on a wireless link is maintained for some delay period even though the end of data transmission is detected (e.g., RLC/MAC send buffer empty). The logical connection is maintained for a predetermined wait period set by a configurable timer. The procedure to release the logical connection is not started until after the timer expires.

The various software layers, routines, or modules described herein may be executable on various processing elements, such as control units discussed above. Each control unit may include a microprocessor, a microcontroller, a processor card (including one or more microprocessors or microcontrollers), or other control or computing devices. As used here, a “controller” can refer to either hardware or software or a combination of the two. A “controller” can also refer to a single component or to plural components (either hardware or software).

A storage unit includes one or more machine-readable storage media for storing data and instructions. The storage media include different forms of memory including semiconductor memory devices such as dynamic or static random access memories (DRAMs or SRAMs), erasable and programmable read-only memories (EPROMs), electrically erasable and programmable read-only memories (EEPROMS) and flash memories; magnetic disks such as fixed, floppy and removable disks; other magnetic media including tape; and optical media such as compact disks (CDs or digital video disks (DVDs). Instructions that make up the various software layers, routines or modules in the various network elements are stored in respective storage units. The instructions when executed by a respective control unit cause the corresponding station or system to perform programmed acts.

The instructions of the software layers, routines or modules are transported to the station or system in one of many different ways. For example, code segments including instructions stored on floppy disks, CD or DVD media, a hard disk, or transported through a network interface card, modem, or other interface device are loaded into the system and executed as corresponding software layers, routines, or modules. In the loading or transport process, data signals that are embodied in carrier waves (transmitted over telephone lines, network lines, wireless links, cables, and the like) communicate the code segments, including instructions, to the network element. Such carrier waves are be in the form of electrical, optical, acoustical, electromagnetic, or other types of signals.

While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method of performing packet-based communications in a wireless network, comprising:
establishing a connection over a wireless link between a mobile station and a radio access network system;
transmitting data in the connection;
waiting a predetermined time delay period after end of data transmission; and
starting a procedure to release the connection after the predetermined delay period.

2. The method of claim 1, wherein starting the procedure comprises sending an indication that the end of data transmission has occurred.

3. The method of claim 2, wherein sending the indication comprises sending a message containing a flag set to a predetermined state.

4. The method of claim 2, further comprising:
receiving an acknowledgement of the indication; and
releasing the connection.

5. The method of claim 4, wherein releasing the connection comprises releasing a temporary block flow in a General Packet Radio Service network.

6. The method of claim 4, wherein releasing the connection comprises releasing a logical connection.

7. The method of claim 6, wherein releasing the logical connection comprises releasing one of plural logical connections assigned on a physical channel.

8. The method of claim 1, wherein the waiting and starting acts are performed in the mobile station.

9. The method of claim 1, wherein the waiting and starting acts are performed in the radio access network system.

10. The method of claim 1, further comprising detecting the end of data transmission.

11. The method of claim 10, wherein detecting the end of data transmission comprises detecting a send data buffer not containing data for transmission on the connection.

12. The method of claim 1, further comprising starting a timer to wait the predetermined time period.

13. The method of claim 1, wherein establishing the connection comprises establishing a temporary block flow in a General Packet Radio Service network.

14. A system for communication in a wireless network, comprising:
an interface to a wireless link;
a control module adapted to establish a connection on the wireless link with a peer system; and
a delay element,
the control module adapted to further detect end of data transmission on the connection and to wait a delay period provided by the delay element before starting a procedure to release the connection.

15. The system of claim 14, wherein the delay element comprises a timer.

16. The system of claim 14, further comprising a radio link control/medium access control layer comprising the control module.

17. The system of claim 14, wherein the control module is adapted to establish a temporary block flow, the connection comprising the temporary block flow.

18. The system of claim 14, comprising a mobile station.

19. The system of claim 14, comprising a base station system.

20. The system of claim 14, further comprising a send buffer, the control module adapted to detect end of data transmission when the send buffer does not have data for transmission on the connection.

21. The system of claim 14, wherein the control module is adapted to start the procedure to release the connection by sending an indication of the end of data transmission.

22. The system of claim 21, wherein the indication comprises a flag having a predetermined state in a data block.

23. The system of claim 21, wherein the control module is adapted to further wait for an acknowledgment of the indication before releasing the connection.

24. The system of claim 14, wherein the control module is adapted to establish a General Packet Radio Service connection.

25. An article comprising at least one storage medium containing instructions for performing packet-based communications in a wireless network, the instructions when executed causing a first system to:
establish a connection between the first system and a peer system over a wireless link; and
wait a predetermined time period at the end of data transmission before providing an indication of the end of data transmission.

26. The article of claim 25, wherein the instructions when executed cause the first system to further detect a data buffer being empty, wherein waiting the predetermined time period is performed after detecting the data buffer is empty.

27. The article of claim 26, wherein the instructions when executed cause the first system to detect the data buffer is empty by detecting a radio link control/medium access control send buffer being empty.

28. The article of claim 25, wherein the instructions when executed cause the first system to wait the predetermined time period by starting a timer.

29. The article of claim 28, wherein the instructions when executed cause the first system to start the timer by starting the timer in a mobile station, the first system comprising the mobile station.

30. The article of claim 28, wherein the instructions when executed cause the first system to start the timer by starting the timer in a base station system, the first system comprising the base station system.

31. The article of claim 25, wherein the instructions when executed cause the first system to establish the connection by establishing a temporary block flow.

32. The article of claim 25, wherein the instructions when executed cause the first system to further release the connection in response to the indication.

33. The article of claim 32, wherein the instructions when executed cause the first system to release the connection by releasing a temporary block flow.

34. A first system, comprising:
means for establishing a connection over a wireless link with a second system;
means for detecting an end of data transmission; and
means for waiting a predetermined time period before providing an indication of the end of data transmission.

35. A data signal embodied in a carrier wave and comprising instructions that when executed cause a first system to:
detect end of data transmission over a connection established on a wireless link;
start a delay period after detecting the end of data transmission; and
start a procedure to release the connection after the delay period.
